(19) United States
(12) Patent Application Publication
(10) Pub. No.: US 2025/0111385 A1
(43) Pub. Date: Apr. 3, 2025

(54) SYSTEMS AND METHODS FOR INTELLIGENT BOOKOUT DISCREPANCY DETECTION

(71) Applicant: Capital One Services, LLC, McLean, VA (US)

(72) Inventors: Michael Garner, Carrollton, TX (US); Bria Burchianti, Frisco, TX (US); Michael McKenna, Little Elm, TX (US)

(21) Appl. No.: 18/374,688

(22) Filed: Sep. 29, 2023

(51) Int. Cl. G06Q 30/018; G06N 20/20; G06Q 10/087; G06Q 30/0201; G06V 30/10

(52) U.S. Cl. CPC G06Q 30/0185; G06N 20/20; G06Q 10/087; G06Q 30/0206; G06V 30/10

(57) ABSTRACT

Disclosed embodiments may include a method for intelligent bookout discrepancy detection. The system may receive bookout data from an automotive dealer, which may include dealer-provided vehicle information that includes a dealer price and dealer-listed features. The system may identify a vehicle identification number from the dealer-provided vehicle information. The system may retrieve third-party vehicle information including at least one of a third-party price and third-party listed features from one or more third party sources using the vehicle identification number. The system may aggregate the third-party vehicle information from the one or more third party sources. The system may determine that a bookout discrepancy exists by comparing the dealer price to the third-party price and comparing dealer-listed features to third-party listed features. The system may flag a contract associated with the bookout data for further review.

The disclosed technology relates to systems and methods for intelligent bookout discrepancy detection. Specifically, this disclosed technology relates to determining whether seller-provided bookout data includes a bookout discrepancy.

### BACKGROUND

Generating a vehicle bookout is a process that provides a lender with a comprehensive summary of a vehicle's value, based on the features and condition (e.g., mileage) of a vehicle. Vehicle bookouts are typically required by auto lenders when financing or refinancing the purchase of a vehicle to determine an amount of a loan that may be issued for the financing of the vehicle and the associated risk being taken on by the lender. Information used to calculate the vehicle bookout is typically furnished by a car dealer to the lending institution. However, in some cases, the car dealers have been known to intentionally try to inflate the bookout value of a vehicle by providing inaccurate information about the features and/or condition of the vehicle, so that a purchaser may qualify for a larger loan. This can be costly for purchasers and create additional financial risk to the lending institution.

Accordingly, there is a need for improved systems and methods for intelligent bookout discrepancy detection. Embodiments of the present disclosure are directed to this and other considerations.

### SUMMARY

Disclosed embodiments may include a system for intelligent bookout discrepancy detection. The system may include one or more processors, and memory in communication with the one or more processors and storing instructions that, when executed by the one or more processors, are configured to cause the system to provide intelligent bookout discrepancy detection. The system may receive bookout data from an automotive dealer, the bookout data including dealer-provided vehicle information comprising a dealer price and dealer-listed features. The system may identify a vehicle identification number from the dealer-provided vehicle information. The system may retrieve third-party vehicle information including at least one of a third-party price and third-party listed features from one or more third party sources using the vehicle identification number. The system may aggregate the third-party vehicle information from the one or more third party sources. The system may determine that a bookout discrepancy exists by comparing the dealer price to the third-party price and comparing dealer-listed features to third-party listed features. The system may flag a contract associated with the bookout data for further review.

Disclosed embodiments may include a system for intelligent bookout discrepancy detection. The system may include one or more processors, and memory in communication with the one or more processors and storing instructions that, when executed by the one or more processors, are configured to cause the system to provide intelligent bookout discrepancy detection. The system may receive bookout data from a seller. The bookout data may include seller-provided information including a seller price and seller-listed features. The system may determine whether the seller price is likely a bookout discrepancy by providing the seller-provided information to a first machine learning model. The system may determine whether the seller-listed features are likely a bookout discrepancy by providing the seller-provided information to a second machine learning model. The system may determine that a bookout discrepancy exists using outputs of the first machine learning model and the second machine learning model. The system may flag a transaction associated with the bookout data for further review in response to determining that a bookout discrepancy exists.

Disclosed embodiments may include a system for intelligent bookout discrepancy detection. The system may include one or more processors, and memory in communication with the one or more processors and storing instructions that, when executed by the one or more processors, are configured to cause the system to provide intelligent bookout discrepancy detection. The system may receive bookout data from an automotive dealer. The bookout data may include dealer-provided vehicle information comprising a dealer price and dealer-listed features. The system may identify a vehicle identification number from the dealer-provided vehicle information. The system may retrieve third-party vehicle information comprising at least one of a third-party price and third-party listed features from one or more third party sources, using the vehicle identification number. The system may aggregate the third-party vehicle information from the one or more third party sources. The system may determine that a bookout discrepancy exists using an ensemble machine learning model, from the third-party vehicle information and the dealer-provided vehicle information by comparing the dealer price to the third-party price and comparing dealer-listed features to third-party listed features. The system may flag a transaction associated with the bookout data for further review.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for intelligent bookout discrepancy detection in accordance with certain embodiments of the disclosed technology.

FIG. 2 is a flow diagram illustrating an exemplary method for intelligent bookout discrepancy detection in accordance with certain embodiments of the disclosed technology.

FIG. 3 is block diagram of an example bookout discrepancy detection system used to provide intelligent bookout discrepancy detection, according to an example implementation of the disclosed technology.

FIG. 4 is block diagram of an example system that may be used to provide intelligent bookout discrepancy detection, according to an example implementation of the disclosed technology.

### DETAILED DESCRIPTION

Examples of the present disclosure related to systems and methods for intelligent bookout discrepancy detection. More particularly, the disclosed technology relates to determining whether bookout data relating to an item (such as a vehicle) includes a bookout discrepancy that may reflect an artificial inflation of the item's value. For example, an automotive dealer may incorrectly list characteristics of a vehicle in a bookout sheet, which may have the effect of artificially increasing the purported value of the vehicle for which a loan is being sought, causing a lender to potentially lend more money for the vehicle than the vehicle is worth. This is a particularly costly problem in the industry of vehicle financing, in which bookout discrepancies are estimated to be in the tens of millions of dollars a year. Tens of millions of auto loans are originated every year and review of all such loans to identify bookout discrepancies is a daunting task and it is estimated that only a small percentage of bookout discrepancies are detected each year currently. Embodiments of the present disclosure relate to techniques for automatic detection of bookout discrepancies that may significantly increase the rate and number of bookout discrepancies detected.

The systems and methods described herein utilize, in some instances, machine learning models, which are necessarily rooted in computers and technology. Machine learning models are a unique computer technology that involves training models to complete tasks and make decisions. The present disclosure details determining whether a bookout discrepancy exists in relation to a given set of bookout data. This, in some examples, may involve using bookout data provided by, for example, an automobile dealer, as input data to a classification machine learning model that may be utilized to compare the dealer-provided bookout data to other data related to the vehicle obtained from third-party sources and/or other similar vehicles to generate an output representing an indication of whether the bookout data includes a bookout discrepancy. Using a machine learning model in this way may allow the system to automatically determine whether it is likely that a given set of bookout data includes a bookout discrepancy. In other words, the system may determine whether the bookout data submitted by, for example, an automotive dealer, includes misrepresentations about the vehicle that are artificially inflating the purported value of the vehicle. This is an advantage and improvement over prior technologies that purport to return a vehicle valuation based on a list of provided features because they require manual entry of features and do not provide any indication of a bookout discrepancy. The present disclosure solves this problem by fully automating the workflow and generating an indication of whether a bookout discrepancy exists. The systems and methods described herein also utilize, in some instances, graphical user interfaces, which are also necessarily rooted in computers and technology. Graphical user interfaces are a computer technology that allows for user interaction with computers through touch, pointing devices, or other means. Overall, the systems and methods disclosed have significant practical applications in the financial technology field because of the noteworthy improvements of the intelligent bookout detection system, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

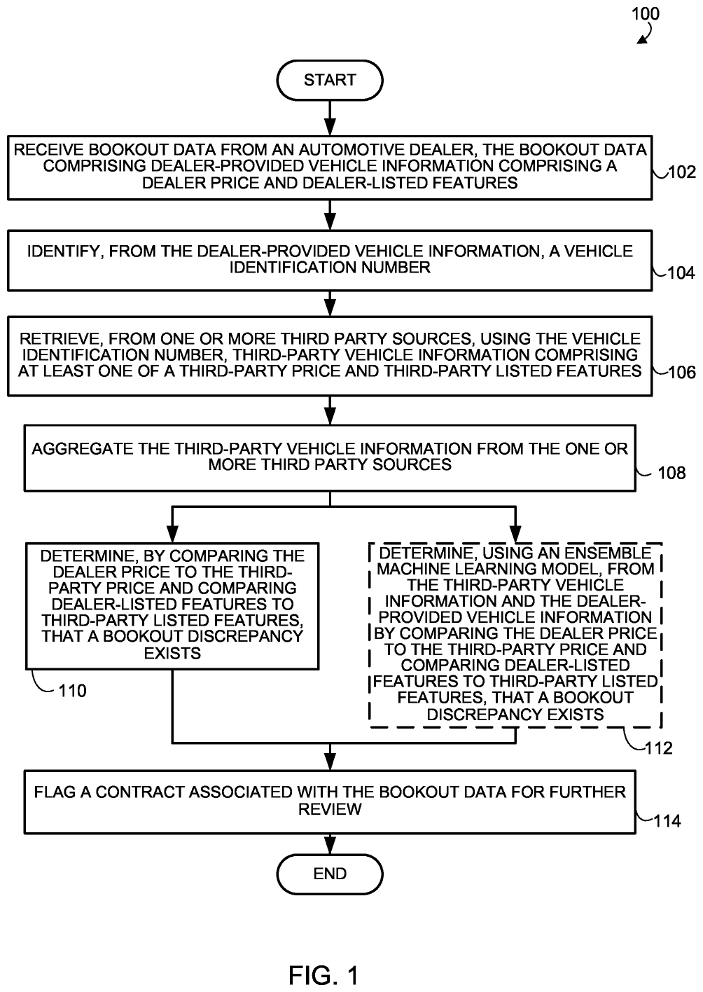

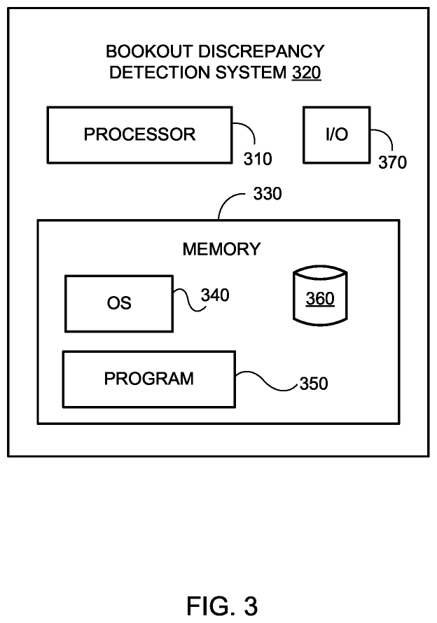

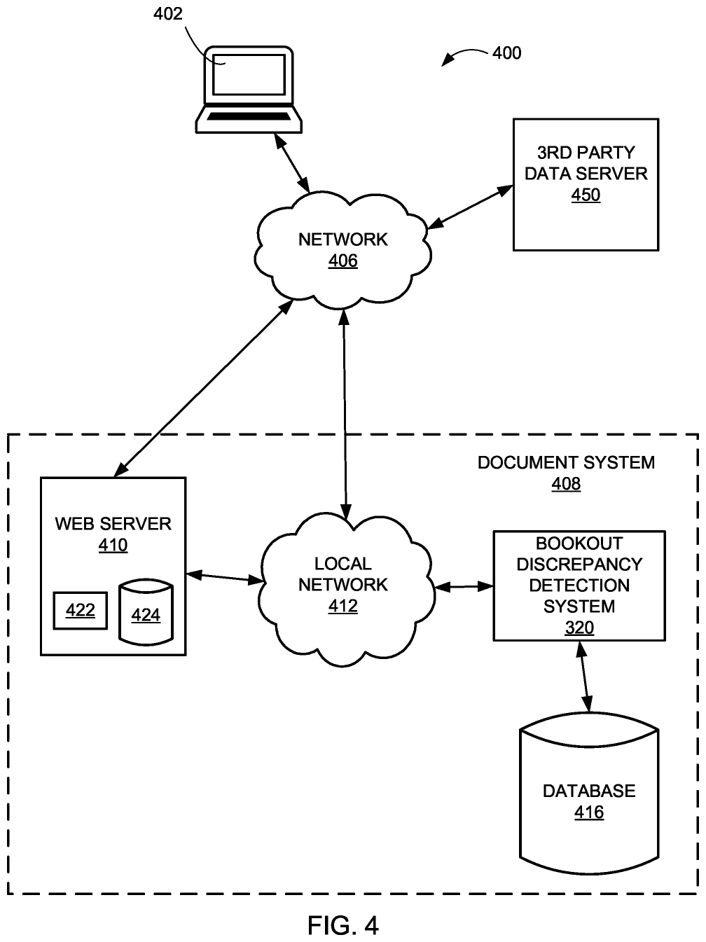

FIG. 1 is a flow diagram illustrating an exemplary method 100 for intelligent bookout discrepancy detection, in accordance with certain embodiments of the disclosed technology. The steps of method 100 may be performed by one or more components of the system 400 (e.g., bookout discrepancy detection system 320 or web server 410 of document system 408 or user device 402), as described in more detail with respect to FIGS. 3 and 4.

In block 102, the bookout discrepancy detection system 320 may receive bookout data from a seller of a vehicle, such as an automotive dealer. For example, it is typical that when a customer seeks to finance the purchase of an automobile, the dealer may fill out what may be referred to as a bookout sheet that includes bookout data, which is data that is typically used by a lender to evaluate and determine aspects of a loan, such as for example, the amount and/or interest rate of the loan. The bookout data may include dealer-provided vehicle information that may include data about the vehicle, such as the make and model of the vehicle, the year of the vehicle, the VIN number of the vehicle, a dealer price and/or dealer-listed features. The dealer price may be the sales price of the automobile and dealer-listed features may be one or more features or aspects of the automobile that may be considered to have an impact on the value of the vehicle. For example, dealer-listed features may include, but are not limited to, the mileage of the vehicle, the condition of the vehicle (e.g., clean, rough, damaged), what type of engine the vehicle has (e.g., V-8, V-6, etc.), the trim level of the vehicle, what type of transmission the vehicle has (e.g., automatic or manual), what type of seats the vehicle has (e.g., leather seats, bucket seats, etc.), what type of tires the vehicle has (e.g., size of tire and whether they are performance tires or not) whether the vehicle is a convertible, and whether the vehicle includes various optional features such as, for example, heating/cooling elements in the seats, a backup camera, a navigation system, a sunroof, a Bluetooth system, a remote start feature, a blind spot monitoring feature, third-row seating, 4-wheel drive, paddle shifters, tinted windows, upgrades to the engine, brakes, exhaust and/or cooling system, a rear spoiler, or any other such feature or option. It will be understood that the listed features are merely exemplary and many other features or aspects may or may not be included as dealer-features according to various embodiments. It will be further understood that each feature or aspect listed in the dealer-listed features will generally have an impact of the value of the vehicle. For example, if a dealer-listed feature includes that the vehicle has pin-striping, this feature may typically add, for example, approximately $200 to the value of the car, thereby justifying a loan amount that is $200 larger than if the vehicle did not have pinstriping as a feature. Thus, the bookout data provided by an automotive dealer may provide a purported value of the vehicle that is based on the dealer-listed features provided by the dealer.

According to some embodiments, the bookout data may be electronically submitted by the automotive dealer. For example, the user device 402 of the dealer may include software that allows the dealer to select or otherwise input the bookout data for a vehicle, which may then be electronically transferred (e.g., via network 406) to the bookout discrepancy detection system 320. In other words, in some embodiments, the bookout discrepancy detection system 320 and/or user device 402 may include an application programming interface (API) that may allow the dealer to input and transmit the bookout data to the bookout discrepancy detection system 320 in an electronic format that the bookout discrepancy detection system 320 is configured to read and process.

However, in some embodiments, receiving the bookout data from the automotive dealer may include receiving image data of a bookout sheet, performing optical character recognition (OCR) on the image data, and retrieving, from the image data, the dealer-provided vehicle information. In other words, in some embodiments, the dealer may, for example, manually fill out printed bookout paperwork that may then be scanned and sent to the bookout discrepancy detection system 320 as an image, PDF file or the like. According to some embodiments, the bookout discrepancy detection system 320 may include software that can perform optical character recognition on one or more images (e.g., a PDF file) that represents the bookout data and extract the bookout data from the image. As will be appreciated by those of skill in the art, OCR may be used to identify letters, numbers and other characters in images such that numbers and letters represented in an image can be identified and put into an electronic format.

In some embodiments, the bookout discrepancy detection system 320 may be configured to receive and/or extract bookout data from an email or other such electronic communication that lists the bookout data. Further, in some embodiments, the bookout data may be received via the dealer filling out an electronic bookout form on a website hosted by the web server 410.

In block 104, the bookout discrepancy detection system 320 may identify a vehicle identification number (VIN) from the dealer-provided vehicle information. According to some embodiments, the VIN may have been provided by the dealer by filling out an electronic form and inputting the VIN in a designated field, in which case the bookout discrepancy detection system 320 may identify the VIN of the vehicle by reading the field of the submitted bookout data that corresponds to the VIN. In some embodiments, the bookout discrepancy detection system 320 may utilize OCR techniques described above to identify, for example, a handwritten VIN from an image representing the bookout data.

In block 106, the bookout discrepancy detection system 320 may retrieve third-party vehicle information including at least one of a third-party price and third-party listed features from one or more third party sources, using the vehicle identification number.

According to some embodiments, the third-party vehicle information may be retrieved from one or more third party sources using application programming interfaces. For example, the bookout discrepancy detection system 320 may include API(s) that are configured to interface with one or more web servers to obtain information about a vehicle based on the VIN number. According to some embodiments, the third-party vehicle information can include a third-party price and third-party listed features that correspond to the vehicle associated with the VIN submitted to the third party source. Third-party sources may include, for example, databases and websites that aggregate vehicle data, such as Edmonds, Carfax, Kelly Blue Book, Black Book, National Automobile Dealers Association (NADA), or other such third-party sources of vehicle information. Third-party sources may also include vehicle manufacturers. Thus, according to some embodiments, the third-party vehicle information retrieved may include a build sheet for the vehicle identification number from a manufacturer. As will be appreciated, various of these third-party sources may be able to provide information about the subject vehicle such as make, model, year, mileage, estimated value, vehicle history (e.g., previous sales and/or accident reports), trim, options, features or other such information about the vehicle that the third-party source may have gathered by whatever means such third-party source uses to gather such information.

According to some embodiments, one or more third-party sources may provide information pertaining to the exact vehicle that corresponds to the VIN. In some embodiments, one or more third-party sources may provide information pertaining to one or more vehicles that are similar to the vehicle that corresponds to the VIN (e.g., vehicles that are the same make, model, year and/or trim). For example, a particular third-party source may know, based on the VIN, the make, model, and year of the vehicle associated with the VIN, but may not have any other information about the features, options, mileage or condition of the vehicle, but may provide known information about similar vehicles. For example, a third-party source may have lots of information about other vehicles of the same make and model, in which each instance of such a vehicle has one of three trim packages and each trim package corresponds to a set of features. Thus, for example, if the first trim package includes no optional features, the second trim package includes optional features A, B, C, D, E and F and the third trim package includes optional features A, D, G, H, I, J, K, this information may be useful in confirming whether dealer-provided information appears to be accurate or not. For example, if the dealer-provided information indicates that the vehicle has optional features B, G, E and K, this may raise a red flag, as this combination of optional features is very divergent from the known trim packages available.

According to some embodiments, the bookout discrepancy detection system 320 and/or web server 410 may include API(s) or other software that is configured to interface with one or more web servers of a third-party source (e.g., 3^{rd} party data server(s) 450) and retrieve third-party information from the third-party source in response to transmitting the VIN to the web server of a third-party source. The third-party source web server may be configured to, for example, receive the VIN from document system 408, access database records corresponding to the VIN and/or similar vehicles, and transmit information from the database records back to the document system 408. According to some embodiments, the bookout discrepancy detection system 320 may be configured to automatically obtain third-party information in response to identifying the VIN from the dealer-provided information as described above in block 104. Thus, for example, in some embodiments, the bookout discrepancy detection system 320 may receive an image of bookout sheet from a dealer (e.g., that has been scanned and emailed to the document system 408), may perform OCR on the image to identify the VIN of the subject vehicle, and then automatically transmit (e.g., via an API of the bookout discrepancy detection system 320 that is integrated with one or more 3^{rd} party data servers 450) the identified VIN to one or more third-party sources to automatically retrieve third-party vehicle information.

According to some embodiments, the document system 408 may utilize a web crawler or other automated web surfing software to obtain third-party vehicle information from one or more websites associated with third-party sources. For example, the bookout discrepancy detection system 320 may include software configured to automatically access one or more third-party websites, navigate the website(s) to locate a VIN input field, automatically input the identified VIN of the subject vehicle into the VIN input field, run a report based on the input VIN, and then copy or otherwise collect third-party vehicle information that is presented by the third-party website in response to performing a search and/or running a report based on the input VIN. According to some embodiments, this may be performed automatically by the bookout discrepancy detection system 320 in response to identifying the VIN from the dealer-provided vehicle information as described above in block 104.

In block 108, the bookout discrepancy detection system 320 may aggregate the third-party vehicle information from the one or more third-party sources. According to some embodiments, aggregating the third-party vehicle information may include combining all of the information together. For example, according to some embodiments, the bookout discrepancy detection system 320 may create a table or spreadsheet (or other form of organized data storage) in which each column represents a different third-party source of data and each row represents a different feature or aspect of the vehicle. For example, rows may represent aspects such as estimated value, mileage, trim type, engine type, whether the vehicle has a sunroof, etc. In some embodiments, if a particular third-party data source does not have information relating to a given aspect (e.g., it has no data on whether the vehicle has a sunroof or not), then that field of the table/spreadsheet may be left blank. According to some embodiments, aggregating the third-party vehicle information may involve utilizing a cloud storage system (such as Amazon Simple Storage Service (S3)), in which third-party vehicle information may be stored in a comma-separated values (CSV) file in which, for example, each row represents a feature of the data.

In block 110, the bookout discrepancy detection system 320 may determine that a bookout discrepancy exists by comparing the dealer price to the third-party price and comparing dealer-listed features to third-party listed features. According to some embodiments, determining that a bookout discrepancy exists in association with a particular set of input bookout data may include determining that a bookout discrepancy exists based on some value (e.g., difference in valuation) exceeding a threshold or may include determining that a bookout discrepancy is likely to exists with a minimal predetermined degree of confidence based on, for example, identified differences in prices, valuations and/or features between the data listed in the bookout data provided by the seller/dealer and data about the same (or in some embodiments, similar) vehicle provided by third-party sources. It should be understood that a determination by the bookout discrepancy detection system 320 that a bookout discrepancy exists does not necessarily mean that a bookout discrepancy does in fact exist, but rather refers to the bookout discrepancy detection system's 320 determination that a bookout discrepancy is likely or probable to exist based.

According to some embodiments, the bookout discrepancy detection system 320 may determine that a bookout discrepancy exists if an average third-party price is different from the dealer price by more than a threshold amount. So, for example, if there are three third-party prices of $45,500, $46,500 and $47,200, respectively, the average third-party price will be $46,400. If the threshold amount is, for example, $500, then in this case the bookout discrepancy detection system 320 would determine that a bookout discrepancy exists when the dealer price is more than $46,900. In some embodiments, the bookout discrepancy detection system 320 may compare the dealer price to the highest third-party price to determine if the threshold has been exceeded. Thus, using the previous example, the highest third-party price is $47,200 and the threshold amount is $500, so the bookout discrepancy detection system 320 will determine that a bookout discrepancy exists if the dealer price is more than $47,700. According to some embodiments, the bookout discrepancy detection system 320 may compare the dealer price to the median third-party price to determine if the threshold has been exceeded. Thus, using the previous example, the median third-party price is $46,500 and the threshold amount is $500, so the bookout discrepancy detection system 320 will determine that a bookout discrepancy exists if the dealer price is more than $47,000.

According to some embodiments, the bookout discrepancy detection system 320 may determine that a bookout discrepancy exists if the set of dealer-listed features differs from one or more sets of third-party listed features by more than a threshold amount. In some embodiments, the bookout discrepancy detection system 320 may determine that a bookout discrepancy exists if the set of dealer price and dealer-listed features differs from one or more sets of a third-party price and third-party listed features by more than a threshold amount. For example, in some embodiments the bookout discrepancy detection system 320 may utilize a trained regression machine learning model to compare features and/or price of dealer-submitted vehicle information to vehicle information provided by one or more third parties and output a degree to which the two sets of features are different and if the degree of difference exceeds a predetermined threshold then the bookout discrepancy detection system 320 may determine that a bookout discrepancy exists. Such machine learning models may be trained using historical data of vehicle data provided by sellers/dealers and associated third-party data on the vehicles in which it is known in which instances the seller/dealer provided data included bookout discrepancies. Thus, as will be understood by those of skill in the art, one or more machine learning models can learn to discern when the degree of differences in listed features and/or price between the seller/dealer provided information and the corresponding third-party information about the vehicle indicate that a bookout discrepancy exists (or is likely to exist).

According to various embodiments, one or more machine learning models may be utilized by the bookout discrepancy detection system 320 in making determinations regarding whether a bookout discrepancy exists (or is likely to exist) in association with a given set of bookout data provided by a seller/dealer. For instance, according to various embodiments, the bookout discrepancy detection system 320 may utilize one or more different types of machine learning models, such as for example, supervised learning models that may perform classifications and utilize logistic regression to determine a discrete output. For example, such a discrete output may be a yes or no indication of whether a bookout discrepancy has been detected (or is suspected of existing with at least a predetermined degree of confidence) in relation to a particular record/set of bookout data furnished by a seller/dealer. Thus, according to some embodiments, determining that a bookout discrepancy exists may involve use of a logistic regression. In some embodiments, a classification model that is trained to determine whether a bookout discrepancy exists may be trained using previous bookout data from files relating to past vehicle sales that are known to include or not include bookout discrepancies. Such a classification model may receive a set of bookout data originating from a seller/dealer as well as third-party vehicle information as inputs and may output a binary determination of whether a bookout discrepancy/fraud is suspected. According to some embodiments, one or more machine learning models described herein may also output a degree of confidence with which a bookout discrepancy is suspected, and if the degree of confidence is above a predetermined threshold level of confidence (e.g., 80%), then the bookout discrepancy detection system 320 may determine that a bookout discrepancy exists.

According to various embodiments, the bookout discrepancy detection system 320 may utilize a supervised learning regression machine learning model to predict, for example, a dollar amount of a bookout discrepancy as a continuous output. In other words, instead of binary output, the model may output a number representative of a dollar amount of a suspected bookout discrepancy. According to some embodiments, if the number output by such a model of the bookout discrepancy detection system 320 is greater than a threshold dollar amount, then bookout discrepancy detection system 320 may determine that a bookout discrepancy exists. According to some embodiments, the threshold dollar amount may be $0.00. In some embodiments, the threshold dollar amount may be a different amount selected by a user or may be a function of the total value of the vehicle (e.g., 1% of the purported value of the vehicle).

According to various embodiments, machine learning models utilized by the bookout discrepancy detection system 320 may utilize one or more various inputs. For example, in some embodiments, one or more machine learning models may include the type of vehicle (e.g., make/model/year), the sales price of the vehicle, an identity of the seller/dealer, features of the sale (e.g., whether it is being financed and for how much, and other such characteristics of the deal), trim level, vehicle options and features (e.g., pinstriping, special wheels, power seats, etc.), and other such details that may be relevant to the value of the vehicle or the reliability of information provided by a given seller/dealer. According to some embodiments, information may be provided by the seller/dealer electronically or the bookout discrepancy detection system 320 that may obtain such data from a bookout sheet using methods such as optical character recognition or handwriting recognition.

According to some embodiments, historical data (e.g., stored in one or more databases) regarding previous bookout data and whether the associated bookout data represented a bookout discrepancy can be used to train various machine learning models to, for example, determine whether a bookout discrepancy exits (or is determined to likely exist) in association with a given set of bookout data received from a seller/dealer. Such historical bookout data may include for example, information about the make/model/year of the vehicle, trim level, options, valuation, VIN number, loan information associated with a purchase of the vehicle, the identity of the seller/dealer, and any other such information as may be impactful in making determinations about the value of a vehicle and/or whether a bookout discrepancy may exist. The historical data may be labeled such that for each vehicle (and its associated bookout data) found in the historical bookout data, the subset of data corresponding to each vehicle may be labeled as having a bookout discrepancy or not. Thus, one or more machine learning models can be trained to identify whether bookout discrepancies exist (or are likely to exist) based on known cases of previous bookout discrepancies that exist within a broader training dataset in which most cases are classified to have not included a bookout discrepancy. According to some embodiments, the historical bookout data may be merged with third-party application programming interfaces (APIs) to be used as input training data to a machine learning model, such as a logistic regression classification model. According to some embodiments, the historical bookout data may be maintained by an organization that, for example has made past loans on vehicle purchases at dealers and has kept track of instances in which dealers have submitted bookout data that have been determined to include a bookout discrepancy. Valuation and bookout sheet details may also be obtained for use as part of the historical/training bookout data from auction data for vehicles that were, for example, auctioned off upon being repossessed. According to some embodiments, an organization that maintains historical bookout data may categorize data received from vehicle auctions as being mispresented or not. According to some embodiments, such data from auction houses (and the third party which provides it) can also be used as training data in training one or more machine learning models to detect bookout discrepancies in input bookout data.

According to various embodiments, neural networks and/or deep learning algorithms may be utilized when working with multiple data sources. For example, some third-party data sources may have better valuation data on vehicles for different regions, may have more details about vehicles from certain manufacturers (e.g., they may have more extensive details about a trim level and options of a vehicle based on the VIN), or may have data that has been manually validated by another third-party, such as an auction house. In some embodiments, these additional details may be used to establish the existence of a bookout discrepancy based on the value of an option or may be used to assign a confidence to the third-party valuation of a vehicle. For example, if a third-part valuation service has detailed trim/options information about a vehicle from the manufacturer that conflicts with bookout details from an auction house, a lower confidence may be assigned to the third-party valuation as additional options/features could have been added to the vehicle by the dealer or previous owners post manufacturing.

In block 112, the bookout discrepancy detection system 320 may optionally (as an alternative to the determination made in block 110) determine, from the third-party vehicle information and the dealer-provided vehicle information by comparing the dealer price to the third-party price and comparing dealer-listed features to third-party listed features, that a bookout discrepancy exists using an ensemble machine learning model.

According to some embodiments, the ensemble machine learning model may include a first machine learning model for comparing the dealer price to the third-party price, a second machine learning model for comparing the dealer-listed features to third-party listed features, and a third machine learning model for combining outputs of the first machine learning model and the second machine learning model. For example, the first machine learning model may be a classification machine learning model that may output a binary indication of whether a bookout discrepancy is likely to exist based on a comparison of the prices provided by the dealer and third-party sources in view of the features of the vehicles listed by each. According to some embodiments the first machine learning model may also output a confidence level associated with its determination. In some embodiments, the second machine learning model may, as described previously above, be trained to output a degree of difference between the features of the vehicle provided by the dealer/seller and the features of the vehicle provided by one or more third-party sources. According to some embodiments, an ensemble model may be trained to take the various outputs of the first and second models and combine them into a final output that provides an indication of whether a bookout discrepancy is detected (or suspected).

According to some embodiments, the ensemble machine learning model may further include a fourth machine learning model for comparing the bookout data to data of known bad actors. In some embodiments, known bad actors may be individuals and/or organizations that have been known to submit bookout discrepancies in the past. The bookout data provided by an automotive dealer may include the name of the salesperson who is submitting the bookout data. According to some embodiments, the bookout discrepancy detection system 320 may store the names of salespeople or organizations who have submitted bookout data in the past that the bookout discrepancy detection system 320 has subsequently determined contains a bookout discrepancy. According to some embodiments, the fourth machine learning model may be trained to determine whether a bad actor is likely involved in the seller/dealer provided bookout data by, for example, comparing information about the people associated with the seller provided bookout data (e.g. the name of one or more salespeople, managers, businesses, locations or regions) In some embodiments, the third machine learning model may combine an output of the fourth machine learning model with the outputs of the first and second machine learning models to generate a final determination of whether a bookout discrepancy is suspected. Thus, for example, if the third machine learning model may be more likely to find that a bookout discrepancy exists based on an output of the fourth machine learning model that indicates that a bad actor is involved (or likely involved) with the transaction presented by the seller/dealer.

In block 114, the bookout discrepancy detection system 320 may flag a contract associated with the bookout data for further review. For example, in some embodiments, flagging a contract associated with the bookout data may include adding an electronic flag to an electronic file associated with the contract. In some embodiments, flagging the contract may include sending an electronic notification to an individual to notify the individual that the contract should be reviewed. For example, the bookout discrepancy detection system 320 may cause a text message, an email or an automated voice call to be made to a person that is responsible for authorizing the contract so that they may review the data to determine whether the information provided is valid or whether the contract/loan amount may need to be revised.

According to some embodiments, flagging the contract associated with the bookout data for further review may include generating a first graphical user interface (GUI) indicating the contract, first information regarding the contract, second information regarding the bookout discrepancy, and an approximate value of the bookout discrepancy, transmitting the first graphical user interface to a user device for display, receiving, from the user device, a request to view the third-party vehicle information, generating a second graphical user interface indicating the third-party vehicle information compared to the dealer-provided vehicle information in graphical form, and transmitting the second graphical user interface to the user device for display. Thus, for example, in some embodiments, the bookout discrepancy detection system 320 may, upon determining that a bookout discrepancy exists (or is likely to exist), generate a GUI for display to a user (e.g., via user device 402) that identifies the contract at issue, notifies the user of a suspected bookout discrepancy and displays an approximate value of the suspected bookout discrepancy. In some embodiments, the user may make a selection using the GUI that causes a second GUI to be generated that may show the third-party vehicle information compared to the dealer-provided information in graphical form so that the user may see a visual representation of the discrepancies between the dealer-provided information and the third-party information.

According to some embodiments, if the bookout discrepancy detection system 320 has determined that a bookout discrepancy exists with respect to a particular file/record (i.e. a particular set of bookout data provided by a seller/dealer), the bookout discrepancy detection system 320 may notify an application programming interface (API) endpoint that can dynamically queue the file/record related to the detected bookout discrepancy in a virtual queue that is displayed on an investigator's device 402 so that the investigator may pull up the file and perform an investigation. In some embodiments, the bookout discrepancy detection system 320 may determine a confidence value to the bookout discrepancy determination and/or a dollar amount of the bookout discrepancy associated with a given file and may dynamically order the virtual queue of files having been identified as having suspected bookout discrepancies based on a priority of each file. For example, files having higher associated dollar amounts of bookout discrepancies and/or higher degrees of confidence that a bookout discrepancy may exist may be placed towards the front of the queue, thereby allowing an investigator to allocate efforts towards files that are most likely to represent fraud and/or have the highest dollar amounts of fraud. In some embodiments, when a new deal/file is submitted to the bookout discrepancy detection system 320, if the bookout discrepancy detection system 320 determines that the new file likely includes a bookout discrepancy, then the bookout discrepancy detection system 320 may send automated alerts to one or more appropriate departments (e.g., sales, loans, customer service, etc.) that include detailed information about the deal and indications regarding why and/or how fraud is suspected.

According to some embodiments, information indicating suspected fraud as determined by the bookout discrepancy detection system 320 may be used as an input to another learning system that may utilize the information in making some decision or taking some action. For example, another learning system may be designed to make a determination regarding whether a loan should be allowed for a vehicle at a specific dealer and the suspected fraud information may be processed by the other learning system to aid in making that determination. Thus, according to some embodiments, the model(s) utilized by the bookout discrepancy detection system 320 may act as a constituent classification model(s) for a larger Random Forest machine learning model. In some embodiments, if the bookout discrepancy detection system 320 determines that a bookout discrepancy likely exists, then the bookout discrepancy detection system 320 may automatically reach out to the dealer (e.g., via email, text message, automated voice call or any other such means of electronic communication that may be automated) associated with the file to seek validation of the data in the bookout data. For example, the bookout discrepancy detection system 320 may request photos of the vehicle or other such information that may be used to verify one or more pieces of data in the bookout data. In some embodiments, the bookout discrepancy detection system 320 may receive information (e.g., digital images or other data) back from the dealer and may attach the received information to the respective file (e.g., a file in the virtual queue) to assist in expediting review and investigation of the file. According to some embodiments, the bookout discrepancy detection system 320 may be capable of performing aspects of an investigation autonomously. For example, according to some embodiments, the bookout discrepancy detection system 320 may utilize one or more machine learning models that may allow it to perform a visual analysis of one or more images provided by a dealer and determine whether vehicle features claimed by the dealer are actually present in the vehicle or not, as shown by the images of the vehicle received from the dealer. In some embodiments, the bookout discrepancy detection system 320 may be configured to automatically (or upon request by an investigator) initiate a telecommunications channel with the dealer, such as a video call, to allow the investigator to remotely inspect the vehicle that is the subject of the bookout data. For instance, according to some embodiments, the bookout discrepancy detection system 320 may cause the user device 402 to display a video call with the dealer along with a GUI that displays a check list of potential discrepancies identified by the bookout discrepancy detection system 320 (e.g., one or more features that the vehicle is purported to have according to the dealer-provided bookout data but that are suspected as not being included on the vehicle based on the third-party data), so that the investigator can remotely visually inspect specific portions of the vehicle identified by the bookout discrepancy detection system 320 and visual evidence of the vehicle can be gathered for the investigative file.

According to some embodiments, the bookout discrepancy detection system 320 may store the dealer-provided vehicle information in an options library. Over time, the options library may include dealer-provided information on a large number of vehicles and associated bookout discrepancy determinations. Thus, in some embodiments, the data in the options library may be used in a manner similar to that described above with respect to the third-party vehicle information to determine whether a bookout discrepancy exists in association with a new set of bookout data. As the options library may be stored locally to the document system 408 (e.g., within database 416), use of the options library to compare vehicle information to the dealer-provided vehicle information may be performed without the retrieving third-party vehicle information, which may require one or more API(s), web crawlers or other software, thereby reducing the resources needed to obtain the data for comparison. In some embodiments, the data in the options library can be used in addition to or in combination with third-party vehicle information.

According to some embodiments, data from the options library can be utilized by one or more machine learning models to assist in determining whether a bookout discrepancy exists. For example, in some embodiments, the dealer-provided vehicle information may be input into, analyzed, or otherwise processed by a machine learning model, which may compare the dealer-provided vehicle information to other data in the options library and may output a preliminary result indicating whether a bookout discrepancy does or does not exist. For example, the data in the options library may represent a plurality of previous instances of bookout data that have been analyzed and determined to either contain bookout discrepancies or to not contain bookout discrepancies. A machine learning model may be trained to attempt to classify or recognize whether a bookout discrepancy exists in a new instance of bookout data. As such, in some embodiments, a new set of bookout data may be input into such a machine learning model and the machine learning model may provide an output that indicates whether the new bookout data is suspected of including a bookout discrepancy or not. Thus, in some embodiments, determining that a bookout discrepancy exists may further include considering an output of a machine learning model that utilizes data in the options library as an input, used for example, as training data to train the machine learning model as described previously above. In some embodiments, data in the options library may be considered historical data used as training data or may be used as training data in addition to historical bookout data stored elsewhere. According to some embodiments, the output of such a machine learning model can be used to determine whether to flag a contract associated with the bookout data for further review (e.g., if the output indicates a bookout discrepancy is detected). In some embodiments, the output of such a machine learning model may be combined or aggregated as part of on an ensemble machine learning model to determine whether to flag the contract.

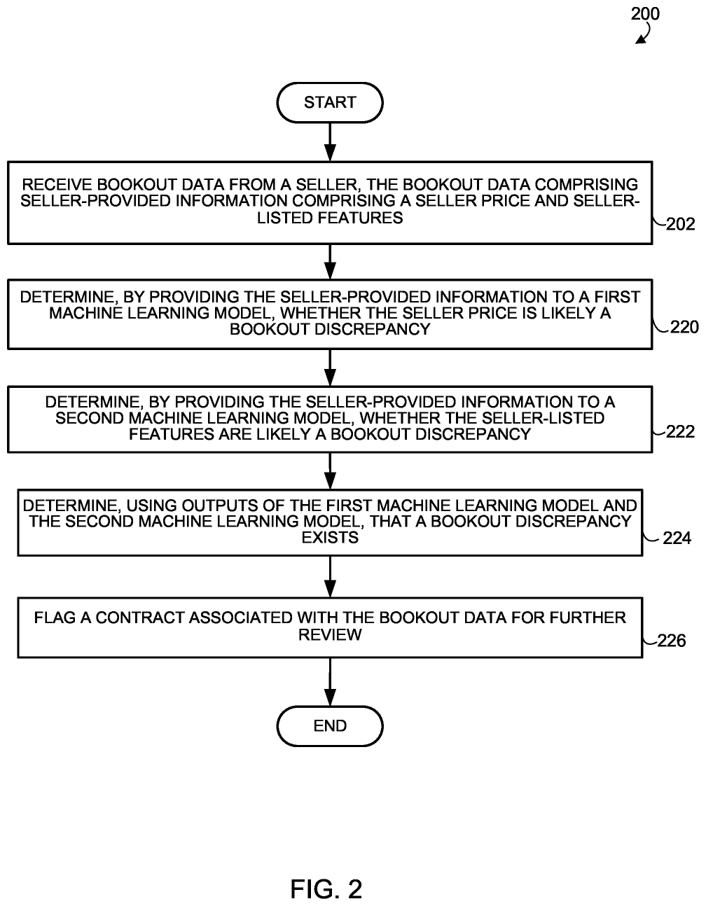

FIG. 2 is a flow diagram illustrating an exemplary method 200 for intelligent bookout discrepancy detection, in accordance with certain embodiments of the disclosed technology. The steps of method 200 may be performed by one or more components of the system 400 (e.g., bookout discrepancy detection system 320 or web server 410 of document system 408 or user device 402), as described in more detail with respect to FIGS. 3 and 4.

In block 202, the bookout discrepancy detection system 320 may receive bookout data from a seller. The bookout data may include seller-provided information including a seller price and seller-listed features. The bookout data may be received in a manner similar to that described above with respect to block 102. For example, according to some embodiments, receiving the bookout data from the seller may include receiving image data of a bookout sheet, performing optical character recognition on the image data, retrieving, from the image data, the seller-provided information, and storing, the seller-provided information in an options library. A seller may be a seller of any item in which the purported value of the item based on features and characteristics of the item may be used to determine a loan amount for financing of the item.

In block 220, the bookout discrepancy detection system 320 may determine whether the seller price is likely a bookout discrepancy by providing the seller-provided information to a first machine learning model. In some embodiments, a first machine learning model may be trained to predict whether the seller price associated with a given set of seller-provided information likely represents a bookout discrepancy in response to the set of seller-provided information being input into the first machine learning model. For example, as described previously above, in some embodiments, a machine learning model may be trained using previous examples of bookout data that contain a bookout discrepancy and examples that do not, to identify whether a new set of seller/dealer provided data is likely to include a bookout discrepancy. According to some embodiments, a machine learning model may be trained on historical data relating to similar vehicles, such as vehicles with the same make, model, year, condition and features to determine whether the seller-provided price is significantly different from what is expected based on previous data. In some embodiments, a machine learning model may take in data about the vehicle provided by third-party sources as previously described above, to determine whether a bookout discrepancy may exist.

In block 222, the bookout discrepancy detection system 320 may determine whether the seller-listed features are likely a bookout discrepancy by providing the seller-provided information to a second machine learning model. In some embodiments, a second machine learning model may be trained to predict whether the seller-listed features associated with a given set of seller-provided information likely represents a bookout discrepancy in response to the set of seller-provided information being input into the first machine learning model. For example, in some embodiments, the second machine learning model may be trained using historical vehicle data of similar makes, models, and years of vehicle along with their associated features to determine whether the features listed with the vehicle associated with the seller-provided bookout data fall in line with what is expected based on similar vehicles or whether there is a discrepancy. For example, if the seller-provided bookout data lists one or more features of the vehicle that no other previous similar vehicle has then the model may determine that there is a high likelihood of a bookout discrepancy. In some embodiments, the second model may utilize third-party provided data about the vehicle as inputs as described previously above in order to determine if the seller-provided information about the features of the vehicle is significantly different from what features the vehicle is expected to have based on the third-party information. According to some embodiments, the second machine learning model may be trained to output a degree of difference of the features of the vehicle to the expected features (e.g., either based on historical data relating to similar vehicles and/or third-party data about that particular vehicle) or may be trained to output a binary indication of whether the degree of difference indicates a bookout discrepancy.

According to some embodiments, the first machine learning model and second machine learning model may use inputs of the seller price and the seller-listed features. The models may be trained using historical vehicle data of similar vehicles and/or historical data of previous instances of bookout data and third-party and/or historical data in which it is known whether each instance of historical bookout data included a bookout discrepancy or not. According to some embodiments, the seller-provided information, which may include the seller price and the seller-listed features, may be input into the first and second machine learning model as, for example, a tuple. In some embodiments, third-party provided data about a subject vehicle may also be provided as an input to the first and/or second machine learning models.

According to some embodiments, the first machine learning model and second machine learning model may use training data from prior customers. For example, in some embodiments, training data may include data representative of prior bookout data sheets in which for each prior bookout data sheet it was determined whether the prior bookout data sheet included a bookout discrepancy or not. In some embodiments, such prior customer data may be stored locally in the options library, as previously described above. Thus, according to some embodiments, the bookout discrepancy detection system 320 may train the first machine learning model and the second machine learning model using the seller-provided information in the options library.

According to some embodiments, the bookout discrepancy detection system 320 may be configured to identify an identification number from the seller-provided information (e.g., a VIN), retrieve, using the identification number, third-party information about an item (e.g., a vehicle) including at least one of a third-party price and third-party listed features from one or more third party sources, aggregate the third-party information from the one or more third party sources, and train the first machine learning model and the second machine learning model using the third-party information and the seller-provided information. In other words, according to some embodiments, as the bookout discrepancy detection system 320 classifies new seller-provided bookout data as including a bookout discrepancy or not, this newly classified bookout data can be added to the options library and used to further train and refine the machine learning models that are used to make further bookout discrepancy determinations.

In block 224, the bookout discrepancy detection system 320 may determine that a bookout discrepancy exists using outputs of the first machine learning model and the second machine learning model. For example, in some embodiments, if the output of either the first or the second machine learning model indicates a bookout discrepancy exists then the bookout discrepancy detection system 320 may determine that a bookout discrepancy exists. In some embodiments, the bookout discrepancy detection system 320 may determine that a bookout discrepancy exists when both outputs of the first and second machine learning model indicate that a bookout discrepancy exists. According to some embodiments, the bookout discrepancy detection system 320 may determine whether a bookout discrepancy exists based on an average of the outputs of the first and second machine learning models. According to some embodiments, determining that a bookout discrepancy exists may include combining the outputs of the first machine learning model and the second machine learning model using a third machine learning model. For example, as previously described above, in some embodiments, and ensemble machine learning model can be trained to make a final determination about whether a bookout discrepancy exists by combining the outputs of two or more other machine learning models.

According to some embodiments, the bookout discrepancy detection system 320 may determine whether the bookout data is similar to known bad actors using the bookout data and a fourth machine learning model. In some embodiments, the document system 408 may store or otherwise have access to data relating to previous cases of bookout discrepancies and one or more parties associated with such cases. For example, if a particular individual has provided one or more instances of bookout data that included a bookout discrepancy in the past, it may be likely that such individual may do so again in the future. Such individuals or organizations may be considered to be bad actors. Accordingly, in some embodiments, a fourth machine learning model may be trained to determine whether a bad actor is likely involved with a transaction represented by the bookout data provided by the seller/dealer as previously described above. According to some embodiments, the output of the fourth machine learning model may be combined by the third machine learning model with the outputs of the first and second machine learning models to output a final determination about whether the seller-provided bookout data is likely to include a bookout discrepancy.

According to some embodiments, a plurality of machine learning models can be used as in an ensemble to determine whether a bookout discrepancy likely exists in association with a given set of bookout data. For example, in some embodiments, the outputs of a first, second, third and/or fourth machine learning model or combinations thereof can be combined into a single output that provides an indication of whether a bookout discrepancy likely exists or not. As will be appreciated of those of skill in the art, ensemble machine learning models can combine the outputs of a plurality of individual machine learning models into one final output by for example, using a majority vote method or averaging the results.

In block 226, the bookout discrepancy detection system 320 may flag a transaction associated with the bookout data for further review in response to determining that a bookout discrepancy exists in a manner similar to that described above with respect block 114.

FIG. 3 is a block diagram of an example bookout discrepancy detection system 320 used to determine that bookout data provided by a seller likely includes a bookout discrepancy according to an example implementation of the disclosed technology. According to some embodiments, the user device 402, web server 410 and 3^{rd} party data server, as depicted in FIG. 4 and described below, may have a similar structure and components that are similar to those described with respect to bookout discrepancy detection system 320 shown in FIG. 3. As shown, the bookout discrepancy detection system 320 may include a processor 310, an input/output (I/O) device 370, a memory 330 containing an operating system (OS) 340 and a program 350. In certain example implementations, the bookout discrepancy detection system 320 may be a single server or may be configured as a distributed computer system including multiple servers or computers that interoperate to perform one or more of the processes and functionalities associated with the disclosed embodiments. In some embodiments bookout discrepancy detection system 320 may be one or more servers from a serverless or scaling server system. In some embodiments, the bookout discrepancy detection system 320 may further include a peripheral interface, a transceiver, a mobile network interface in communication with the processor 310, a bus configured to facilitate communication between the various components of the bookout discrepancy detection system 320, and a power source configured to power one or more components of the bookout discrepancy detection system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the bookout discrepancy detection system 320 may include one or more storage devices configured to store information used by the processor 310 (or other components) to perform certain functions related to the disclosed embodiments. In one example, the bookout discrepancy detection system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The bookout discrepancy detection system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the bookout discrepancy detection system 320 may include the memory 330 that may include one or more programs 350 to perform one or more functions of the disclosed embodiments. For example, in some embodiments, the bookout discrepancy detection system 320 may include programs 350 for identifying a VIN from bookout data, retrieving third-party information from third-party sources, aggregating third-party information from a plurality of third-party sources, determining whether a bookout discrepancy exists, training and utilizing one or more machine learning models that are used in determining whether a bookout discrepancy exists, flagging a contract for further review, and generating GUIs that can be accessed and interacted with by a user device 402.

The processor 310 may execute one or more programs 350 located remotely from the bookout discrepancy detection system 320. For example, the bookout discrepancy detection system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a bookout discrepancy detection system database 360 for storing related data to enable the bookout discrepancy detection system 320 to perform one or more of the processes and functionalities associated with the disclosed embodiments.

According to some embodiments, the bookout discrepancy detection system database 360 may include stored data relating to historical bookout data, an options library, data relating to previous incidents of bookout discrepancies and/or bad actors, data relating to one or more machine learning models, including training data, or any other such data as may be useful to performing one or more functions of the bookout discrepancy detection system 320 as described herein. According to some embodiments, the functions provided by the bookout discrepancy detection system database 360 may also be provided by a database that is external to the bookout discrepancy detection system 320, such as the database 416 as shown in FIG. 4.

The bookout discrepancy detection system 320 may also be communicatively connected to one or more memory devices (e.g., databases) locally or through a network. The remote memory devices may be configured to store information and may be accessed and/or managed by the bookout discrepancy detection system 320. By way of example, the remote memory devices may be document management systems, Microsoft SQL database, SharePoint™ databases, Oracle™ databases, Sybase™ databases, or other relational or non-relational databases. Systems and methods consistent with disclosed embodiments, however, are not limited to separate databases or even to the use of a database.

The bookout discrepancy detection system 320 may also include one or more I/O devices 370 that may comprise one or more interfaces for receiving signals or input from devices and providing signals or output to one or more devices that allow data to be received and/or transmitted by the bookout discrepancy detection system 320. For example, the bookout discrepancy detection system 320 may include interface components, which may provide interfaces to one or more input devices, such as one or more keyboards, mouse devices, touch screens, track pads, trackballs, scroll wheels, digital cameras, microphones, sensors, and the like, that enable the bookout discrepancy detection system 320 to receive data from a user (such as, for example, via the user device 402).

In examples of the disclosed technology, the bookout discrepancy detection system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The bookout discrepancy detection system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The bookout discrepancy detection system 320 may be configured to adjust model parameters during training. Model parameters may include weights, coefficients, offsets, or the like. Training may be supervised or unsupervised.

The bookout discrepancy detection system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The bookout discrepancy detection system 320 may be configured to optimize statistical models using known optimization techniques.

The supervised training in some examples can use a neural network training algorithm while the machine learning model is offline before being deployed in the system and/or subsequent to deployment in order to continually improve accuracy. Accordingly, the system may utilize deep learning models, such as a convolutional neural network (CNN) or long short-term memory (LSTM), for example. In other examples, the machine learning model may be a binary classifier, such as a Support Vector Machine (SVM), Logistic Regression, Random Forest, or XGBoost, for example, and other types of machine learning models can also be used in other examples.

Furthermore, the bookout discrepancy detection system 320 may include programs configured to retrieve, store, and/or analyze properties of data models and datasets. For example, bookout discrepancy detection system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The bookout discrepancy detection system 320 may include algorithms to determine a data type, key-value pairs, row-column data structure, statistical distributions of information such as keys or values, or other property of a data schema may be configured to return a statistical profile of a dataset (e.g., using a data-profiling model). The bookout discrepancy detection system 320 may be configured to implement univariate and multivariate statistical methods. The bookout discrepancy detection system 320 may include a regression model, a Bayesian model, a statistical model, a linear discriminant analysis model, or other classification model configured to determine one or more descriptive metrics of a dataset. For example, bookout discrepancy detection system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The bookout discrepancy detection system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, bookout discrepancy detection system 320 may be configured to generate a similarity metric representing a measure of similarity between data in a dataset. A similarity metric may be based on a correlation, covariance matrix, a variance, a frequency of overlapping values, or other measure of statistical similarity.

The bookout discrepancy detection system 320 may be configured to generate a similarity metric based on data model output, including data model output representing a property of the data model. For example, bookout discrepancy detection system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The bookout discrepancy detection system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The bookout discrepancy detection system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, bookout discrepancy detection system 320 is configured to generate and/or train a classification model to classify a dataset, consistent with disclosed embodiments.

The bookout discrepancy detection system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the bookout discrepancy detection system may analyze information applying machine-learning methods.

While the bookout discrepancy detection system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the bookout discrepancy detection system 320 may include a greater or lesser number of components than those illustrated.

FIG. 4 is a block diagram of an example system that may be used to view and interact with document system 408, according to an example implementation of the disclosed technology. The components and arrangements shown in FIG. 4 are not intended to limit the disclosed embodiments as the components used to implement the disclosed processes and features may vary. As shown, document system 408 may interact with a user device 402 and/or one or more 3rd party data servers 450 via a network 406. In certain example implementations, the document system 408 may include a local network 412, a bookout discrepancy detection system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the document system 408. In some embodiments, the user device 402 may include or incorporate electronic communication devices for hearing or vision impaired users.

Users may include individuals such as, for example, employees, subscribers, clients, prospective clients, or customers of an entity associated with an organization, such as individuals who have obtained, will obtain, or may obtain a product, service, or consultation from or conduct a transaction in relation to an entity associated with the document system 408. For example, in some embodiments, users may include salespeople of a car dealership that may use user device 408 to submit bookout data to the documents system 408 or otherwise interact with document system 408. User may include employees of an organization associated with document system 408. For example, a user may be an employee of a lending institution and the employee may utilize user device 402 to receive notifications, warnings, data and/or graphical user interfaces from the bookout discrepancy detection system 320. In some embodiments, an employee may use user device 402 to review a contract or other information associated with bookout data that has been flagged as being suspected of including a bookout discrepancy. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The bookout discrepancy detection system 320 may include programs (scripts, functions, algorithms) to configure data for visualizations and provide visualizations of datasets and data models on the user device 402. This may include programs to generate graphs and display graphs. The bookout discrepancy detection system 320 may include programs to generate histograms, scatter plots, time series, or the like on the user device 402. The bookout discrepancy detection system 320 may also be configured to display properties of data models and data model training results including, for example, architecture, loss functions, cross entropy, activation function values, embedding layer structure and/or outputs, convolution results, node outputs, or the like on the user device 402. The bookout discrepancy detection system 320 may include programs to generate and cause user device 402 to display one or more graphical user interfaces.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The document system 408 may be associated with and optionally controlled by one or more entities such as a business, corporation, individual, partnership, or any other entity that provides one or more of goods, services, and consultations to individuals such as customers. In some embodiments, the document system 408 may be controlled by a third party on behalf of another business, corporation, individual, partnership. The document system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the bookout discrepancy detection system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™. According to some embodiments, the web server 410 may host a website that includes a bookout data form in which a user of a user device 402 may electronically submit bookout data into predefined fields.

The local network 412 may include any type of computer networking arrangement used to exchange data in a localized area, such as WiFi, Bluetooth™, Ethernet, and other suitable network connections that enable components of the document system 408 to interact with one another and to connect to the network 406 for interacting with components in the system 400 environment. In some embodiments, the local network 412 may include an interface for communicating with or linking to the network 406. In other embodiments, certain components of the document system 408 may communicate via the network 406, without a separate local network 406.

The document system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access document system 408 using the cloud computing environment. User device 402 may be able to access document system 408 using specialized software. The cloud computing environment may eliminate the need to install specialized software on user device 402.

In accordance with certain example implementations of the disclosed technology, the document system 408 may include one or more computer systems configured to compile data from a plurality of sources the bookout discrepancy detection system 320, web server 410, and/or the database 416. The bookout discrepancy detection system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

3^{rd} party data server 450 may include a computer system or server configured to store or host 3^{rd} party information about items that may be the subject of financing, such as vehicles. 3^{rd} party data servers 450 may include website servers for websites that aggregate item data, such as websites that aggregate information about vehicles. Such websites may store third-party prices that are estimates of the values of each vehicle as determined by the third-party. They may also include third-party listed features, which are the features, characteristics or other aspects of a vehicle that may have an impact on the vehicle's value. In some embodiments, 3^{rd} party data servers 450 may include servers associated with vehicle manufacturers, which may host vehicle information such as build sheets, which list the features of a vehicle at the time it was built. As described herein, in some embodiments, the bookout discrepancy detection system 320 may obtain third-party vehicle information from one or more 3^{rd} party data servers 450 based on the VIN of a vehicle. Although this description is generally directed towards use of the bookout discrepancy detection system 320 for detecting bookout discrepancies from vehicle sellers, it is contemplated that the bookout discrepancy detection system 320 may be applied to other types of items in which bookout discrepancies may be an issue and third-party information about the items may be available for comparison.

Although the preceding description describes various functions of a web server 410, a bookout discrepancy detection system 320, a database 416, a 3^{rd} party data server 450, and user device 402 in some embodiments, some or all of these functions may be carried out by a single computing device.

### Example Use Case

The following example use case describes an example of a typical user flow pattern. This section is intended solely for explanatory purposes and not in limitation.

In one example, a salesperson at an automotive dealership may be attempting to sell a used car to a customer and may have reached a tentative agreement on the sales price of the vehicle. However, the customer wants to finance the purchase of the vehicle with a loan, which may require the salesperson to provide a lender with bookout data that provides information about the features of the vehicle and the value of the vehicle. The salesperson may print a bookout sheet and manually fill in the information about the vehicle, such as the make, model, VIN, and various features included in the vehicle. The salesperson may then scan and email the bookout sheet to the lender's system. The lender's system (e.g., bookout discrepancy detection system 320) may apply optical character recognition to an image of the bookout sheet to extract electronic representations of the bookout data. The lender's system may then determine whether the bookout data provided by the dealer contains a bookout discrepancy or not by, for example, obtaining third-party vehicle information about the vehicle from third-party sources based on the VIN of the vehicle and then comparing the third-party vehicle information to the dealer-provided vehicle/pricing information to see if there are any significant discrepancies. The lender's system may employ one or more machine learning models to aid in making this determination. If the lender's system determines that a bookout discrepancy exists, then the system may flag the contract associated with the subject vehicle for further review. The system may, for example, generate a GUI on an employee device that presents them with a warning that the bookout data related to this contract is suspected of having been misrepresented to increase the loan value and may provide the employee with options for addressing the issue, such as performing an investigation into the file and/or contacting the dealer to provide validating information. The GUI may display a virtual queue of contracts associated with bookout data that are suspected of having a bookout discrepancies. The GUI may be configured to dynamically order and reorder the virtual queue to prioritize contracts having the highest value and/or the highest level of suspicion of including a bookout discrepancy. Upon determining that a bookout discrepancy is likely to exist, the lender's system may be configured to automatically take actions to investigate the file, such as automatically reaching out to the dealer (e.g., via email, text, automated voice call, etc.) to request specific pieces of information, such as for example, images or video of one or more parts of the vehicles to validate purported options/features of the vehicle listed in the bookout data. Alternatively, the lender's system may be configured to automatically connect the employee to a representative of the dealer via, for example, video call, to allow the employee to remotely perform an inspection of the vehicle as part of an investigation into the accuracy of the bookout data.

In some examples, disclosed systems or methods may involve one or more of the following clauses:

Clause 1: A bookout discrepancy detection system comprising: one or more processors; memory in communication with the one or more processors and storing instructions that are configured to cause the bookout discrepancy detection system to: receive bookout data from an automotive dealer, the bookout data comprising dealer-provided vehicle information comprising a dealer price and dealer-listed features; identify, from the dealer-provided vehicle information, a vehicle identification number; retrieve, from one or more third party sources, using the vehicle identification number, third-party vehicle information comprising at least one of a third-party price and third-party listed features; aggregate the third-party vehicle information from the one or more third party sources; determine, by comparing the dealer price to the third-party price and comparing dealer-listed features to third-party listed features, that a bookout discrepancy exists; and flag a contract associated with the bookout data for further review.

Clause 2: The bookout discrepancy detection system of clause 1, wherein receiving the bookout data from the automotive dealer comprises: receiving image data of a bookout sheet; performing optical character recognition on the image data; and retrieving, from the image data, the dealer-provided vehicle information.

Clause 3: The bookout discrepancy detection system of clause 2, wherein the memory stores further instructions that are configured to cause the bookout discrepancy detection system to store the dealer-provided vehicle information in an options library.

Clause 4: The bookout discrepancy detection system of clause 3, wherein the dealer-provided vehicle information is analyzed by a first machine learning model, which compares the dealer-provided vehicle information to other data in the options library and outputs a preliminary result indicating whether a bookout discrepancy does or does not exist, and wherein determining that a bookout discrepancy exists further comprises considering an output of the first machine learning model.

Clause 5: The bookout discrepancy detection system of clause 1, wherein the third-party vehicle information is retrieved from one or more third party sources using application programming interfaces.

Clause 6: The bookout discrepancy detection system of clause 1, wherein the third-party vehicle information retrieved is a build sheet for the vehicle identification number from a manufacturer.

Clause 7: The bookout discrepancy detection system of clause 1, wherein determining that a bookout discrepancy exists uses a logistic regression.

Clause 8: The bookout discrepancy detection system of clause 1, wherein flagging the contract associated with the bookout data for further review comprises: generating a first graphical user interface indicating the contract, first information regarding the contract, second information regarding the bookout discrepancy, and an approximate value of the bookout discrepancy; transmitting the first graphical user interface to a user device for display; receiving, from the user device, a request to view the third-party vehicle information; generating a second graphical user interface indicating the third-party vehicle information compared to the dealer-provided vehicle information in graphical form; and transmitting the second graphical user interface to the user device for display.

Clause 9: A bookout discrepancy prediction system comprising: one or more processors; memory in communication with the one or more processors and storing instructions that are configured to cause the bookout discrepancy prediction system to: receive bookout data from a seller, the bookout data comprising seller-provided information comprising a seller price and seller-listed features; determine, by providing the seller-provided information to a first machine learning model, whether the seller price is likely a bookout discrepancy; determine, by providing the seller-provided information to a second machine learning model, whether the seller-listed features are likely a bookout discrepancy; determine, using outputs of the first machine learning model and the second machine learning model, that a bookout discrepancy exists; and responsive to determining that a bookout discrepancy exists: flag a transaction associated with the bookout data for further review.

Clause 10: The bookout discrepancy prediction system of clause 9, wherein the first machine learning model and second machine learning model use inputs of the seller price and the seller-listed features.

Clause 11: The bookout discrepancy prediction system of clause 9, wherein determining that a bookout discrepancy exists further comprises: combining, the outputs of the first machine learning model and the second machine learning model using a third machine learning model.

Clause 12: The bookout discrepancy prediction system of clause 11, wherein the memory stores further instructions that are configured to cause the bookout discrepancy detection system to determine, using a fourth machine learning model, and the bookout data, whether the bookout data is similar to known bad actors, and wherein the third machine learning model also combines an output of the fourth machine learning model.

Clause 13: The bookout discrepancy prediction system of clause 9, wherein the first machine learning model and second machine learning model use training data from prior customers.

Clause 14: The bookout discrepancy prediction system of clause 9, wherein receiving the bookout data from the seller comprises: receiving image data of a bookout sheet; performing optical character recognition on the image data; retrieving, from the image data, the seller-provided information; and storing the seller-provided information in an options library.

Clause 15: The bookout discrepancy prediction system of clause 14, wherein the memory stores further instructions that are configured to cause the bookout discrepancy detection system to train the first machine learning model and the second machine learning model using the seller-provided information in the options library.

Clause 16: The bookout discrepancy prediction system of clause 9, wherein the memory stores further instructions that are configured to cause the bookout discrepancy detection system to: identify, from the seller-provided information, an identification number; retrieve, from one or more third party sources, using the identification number, third-party information about an item comprising at least one of a third-party price and third-party listed features; aggregate the third-party information from the one or more third party sources; and train the first machine learning model and the second machine learning model using the third-party information and the seller-provided information.

Clause 17: A bookout discrepancy detection system comprising: one or more processors; memory in communication with the one or more processors and storing instructions that are configured to cause the bookout discrepancy detection system to: receive bookout data from an automotive dealer, the bookout data comprising dealer-provided vehicle information comprising a dealer price and dealer-listed features; identify, from the dealer-provided vehicle information, a vehicle identification number; retrieve, from one or more third party sources, using the vehicle identification number, third-party vehicle information comprising at least one of a third-party price and third-party listed features; aggregate the third-party vehicle information from the one or more third party sources; determine, using an ensemble machine learning model, from the third-party vehicle information and the dealer-provided vehicle information by comparing the dealer price to the third-party price and comparing dealer-listed features to third-party listed features, that a bookout discrepancy exists; and flag a transaction associated with the bookout data for further review.

Clause 18: The bookout discrepancy detection system of clause 17, wherein the ensemble machine learning model comprises: a first machine learning model for comparing the dealer price to the third-party price; a second machine learning model for comparing the dealer-listed features to third-party listed features; and a third machine learning model for combining outputs of the first machine learning model and the second machine learning model.

Clause 19: The bookout discrepancy detection system of clause 18, wherein the ensemble machine learning model further comprises a fourth machine learning model for comparing the bookout data to data of known bad actors, and wherein the third machine learning model also combines an output of the fourth machine learning model.

Clause 20: The bookout discrepancy detection system of clause 17, wherein flagging the transaction associated with the bookout data for further review comprises: generating a first graphical user interface indicating the transaction, first information regarding the transaction, second information regarding the bookout discrepancy, and an approximate value of the bookout discrepancy; transmitting the first graphical user interface to a user device for display; receiving, from the user device, a request to view the third-party vehicle information; generating a second graphical user interface indicating the third-party vehicle information compared to the dealer-provided vehicle information in graphical form; and transmitting the second graphical user interface to the user device for display.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A bookout discrepancy detection system comprising:
one or more processors;
memory in communication with the one or more processors and storing instructions that are configured to cause the bookout discrepancy detection system to:
receive bookout data from an automotive dealer, the bookout data comprising dealer-provided vehicle information comprising a dealer price and dealer-listed features;
identify, from the dealer-provided vehicle information, a vehicle identification number;
retrieve, from one or more third party sources, using the vehicle identification number, third-party vehicle information comprising at least one of a third-party price and third-party listed features;
aggregate the third-party vehicle information from the one or more third party sources;
determine, by comparing the dealer price to the third-party price and comparing dealer-listed features to third-party listed features, that a bookout discrepancy exists; and
flag a contract associated with the bookout data for further review.

2. The bookout discrepancy detection system of claim 1, wherein receiving the bookout data from the automotive dealer comprises:
receiving image data of a bookout sheet;
performing optical character recognition on the image data; and
retrieving, from the image data, the dealer-provided vehicle information.

3. The bookout discrepancy detection system of claim 2, wherein the memory stores further instructions that are configured to cause the bookout discrepancy detection system to store the dealer-provided vehicle information in an options library.

4. The bookout discrepancy detection system of claim 3, wherein the dealer-provided vehicle information is analyzed by a first machine learning model, which compares the dealer-provided vehicle information to other data in the options library and outputs a preliminary result indicating whether a bookout discrepancy does or does not exist, and wherein determining that a bookout discrepancy exists further comprises considering an output of the first machine learning model.

5. The bookout discrepancy detection system of claim 1, wherein the third-party vehicle information is retrieved from one or more third party sources using application programming interfaces.

6. The bookout discrepancy detection system of claim 1, wherein the third-party vehicle information retrieved is a build sheet for the vehicle identification number from a manufacturer.

7. The bookout discrepancy detection system of claim 1, wherein determining that a bookout discrepancy exists uses a logistic regression.

8. The bookout discrepancy detection system of claim 1, wherein flagging the contract associated with the bookout data for further review comprises:
generating a first graphical user interface indicating the contract, first information regarding the contract, second information regarding the bookout discrepancy, and an approximate value of the bookout discrepancy;
transmitting the first graphical user interface to a user device for display;
receiving, from the user device, a request to view the third-party vehicle information;
generating a second graphical user interface indicating the third-party vehicle information compared to the dealer-provided vehicle information in graphical form; and
transmitting the second graphical user interface to the user device for display.

9. A bookout discrepancy prediction system comprising:
one or more processors;
memory in communication with the one or more processors and storing instructions that are configured to cause the bookout discrepancy prediction system to:
receive bookout data from a seller, the bookout data comprising seller-provided information comprising a seller price and seller-listed features;
determine, by providing the seller-provided information to a first machine learning model, whether the seller price is likely a bookout discrepancy;
determine, by providing the seller-provided information to a second machine learning model, whether the seller-listed features are likely a bookout discrepancy;
determine, using outputs of the first machine learning model and the second machine learning model, that a bookout discrepancy exists; and
responsive to determining that a bookout discrepancy exists:
flag a transaction associated with the bookout data for further review.

10. The bookout discrepancy prediction system of claim 9, wherein the first machine learning model and second machine learning model use inputs of the seller price and the seller-listed features.

11. The bookout discrepancy prediction system of claim 9, wherein determining that a bookout discrepancy exists further comprises:
combining the outputs of the first machine learning model and the second machine learning model using a third machine learning model.

12. The bookout discrepancy prediction system of claim 11, wherein the memory stores further instructions that are configured to cause the bookout discrepancy detection system to determine, using a fourth machine learning model, and the bookout data, whether the bookout data is similar to known bad actors, and wherein the third machine learning model also combines an output of the fourth machine learning model.

13. The bookout discrepancy prediction system of claim 9, wherein the first machine learning model and second machine learning model use training data from prior customers.

14. The bookout discrepancy prediction system of claim 9, wherein receiving the bookout data from the seller comprises:
receiving image data of a bookout sheet;
performing optical character recognition on the image data;
retrieving, from the image data, the seller-provided information; and
storing the seller-provided information in an options library.

15. The bookout discrepancy prediction system of claim 14, wherein the memory stores further instructions that are configured to cause the bookout discrepancy detection system to train the first machine learning model and the second machine learning model using the seller-provided information in the options library.

16. The bookout discrepancy prediction system of claim 9, wherein the memory stores further instructions that are configured to cause the bookout discrepancy detection system to:
identify, from the seller-provided information, an identification number;
retrieve, from one or more third party sources, using the identification number, third-party information about an item comprising at least one of a third-party price and third-party listed features;
aggregate the third-party information from the one or more third party sources; and
train the first machine learning model and the second machine learning model using the third-party information and the seller-provided information.

17. A bookout discrepancy detection system comprising:
one or more processors;
memory in communication with the one or more processors and storing instructions that are configured to cause the bookout discrepancy detection system to:
receive bookout data from an automotive dealer, the bookout data comprising dealer-provided vehicle information comprising a dealer price and dealer-listed features;
identify, from the dealer-provided vehicle information, a vehicle identification number;
retrieve, from one or more third party sources, using the vehicle identification number, third-party vehicle information comprising at least one of a third-party price and third-party listed features;
aggregate the third-party vehicle information from the one or more third party sources;
determine, using an ensemble machine learning model, from the third-party vehicle information and the dealer-provided vehicle information by comparing the dealer price to the third-party price and comparing dealer-listed features to third-party listed features, that a bookout discrepancy exists; and
flag a transaction associated with the bookout data for further review.

18. The bookout discrepancy detection system of claim 17, wherein the ensemble machine learning model comprises:
a first machine learning model for comparing the dealer price to the third-party price;
a second machine learning model for comparing the dealer-listed features to third-party listed features; and
a third machine learning model for combining outputs of the first machine learning model and the second machine learning model.

19. The bookout discrepancy detection system of claim 18, wherein the ensemble machine learning model further comprises a fourth machine learning model for comparing the bookout data to data of known bad actors, and wherein the third machine learning model also combines an output of the fourth machine learning model.

20. The bookout discrepancy detection system of claim 17, wherein flagging the transaction associated with the bookout data for further review comprises:
generating a first graphical user interface indicating the transaction, first information regarding the transaction, second information regarding the bookout discrepancy, and an approximate value of the bookout discrepancy;
transmitting the first graphical user interface to a user device for display;
receiving, from the user device, a request to view the third-party vehicle information;
generating a second graphical user interface indicating the third-party vehicle information compared to the dealer-provided vehicle information in graphical form; and
transmitting the second graphical user interface to the user device for display.
